(19) United States
(12) Patent Application Publication
(10) Pub. No.: US 2010/0012469 A1
(43) Pub. Date: Jan. 21, 2010

(54) CONVEYOR SYSTEM

(76) Inventors: Stephen Szarkowski, Pueblo, CO (US); Rodney Mishmash, Pueblo, CO (US); David Pruett, Canon City, CO (US); Raymond Middlemiss, Canon City, CO (US); Tom Harding, Canon City, CO (US)

Correspondence Address: KLAAS, LAW, O''MEARA & MALKIN, P.C., 1999 BROADWAY, SUITE 2225, DENVER, CO, 80202, US

(21) Appl. No.: 12/349,443

(22) Filed: Jan. 6, 2009

Related U.S. Application Data
(60) Provisional application No. 61/081,117, filed on Jul. 16, 2008.

(51) Int. Cl. B65G 23/18

(52) U.S. Cl. 198/805

(57) ABSTRACT

A conveyor system is disclosed herein. An embodiment of the conveyor system comprises a first end; a second end; and a belt extending between the first end and the second end, wherein the belt has a belt first side; and wherein a magnetic force acts on the belt first side.

This application is a continuation of and claims priority to U.S. provisional application 61/081,117 filed on Jul. 16, 2008, which is hereby incorporated by reference for all that is disclosed therein.

### BACKGROUND

Belt conveyor systems use belts to convey items. Conventional belt conveyor systems use rollers, guides, and other mechanisms to orient the belt or to maintain tension on the belt. For example in a curved conveyor system, guides, rollers, and other mechanisms are used to maintain tension on the belt. Without the tension, the belt will become unstable, which will cause the conveyor to fail.

The aforementioned rollers, guides, and other mechanisms used to orient the belt generate a great amount of friction. This friction increases the power required to operate the conveyor in addition to the amount of noise generated by the conveyor. The mechanisms also limit the speed at which the conveyors, especially curved conveyors can operate.

### BRIEF DESCRIPTION OF THE DRAWINGS

FIG. 1 is a top view of an embodiment of a conveyor system.

FIG. 2 is a perspective view of the first end of the conveyor system of FIG. 1 showing some of the internal components of the conveyor system.

FIG. 3 is a top view of the conveyor system of FIG. 1 with the belt removed.

FIG. 4 is an exploded view of an embodiment of a portion of a chain used in the conveyor system of FIG. 3.

FIG. 5 is a bottom view of an embodiment of the conveyor system of FIG. 1.

FIG. 6 is a side cutaway of an other embodiment of a portion of the conveyor system of FIG. 1.

FIG. 7 is side cut away view of an embodiment of the return path of the conveyor of FIG. 1.

FIG. 8 is a top view of an embodiment of a chain retainer.

FIG. 9 is a side view of the chain retainer of FIG. 8.

### DETAILED DESCRIPTION

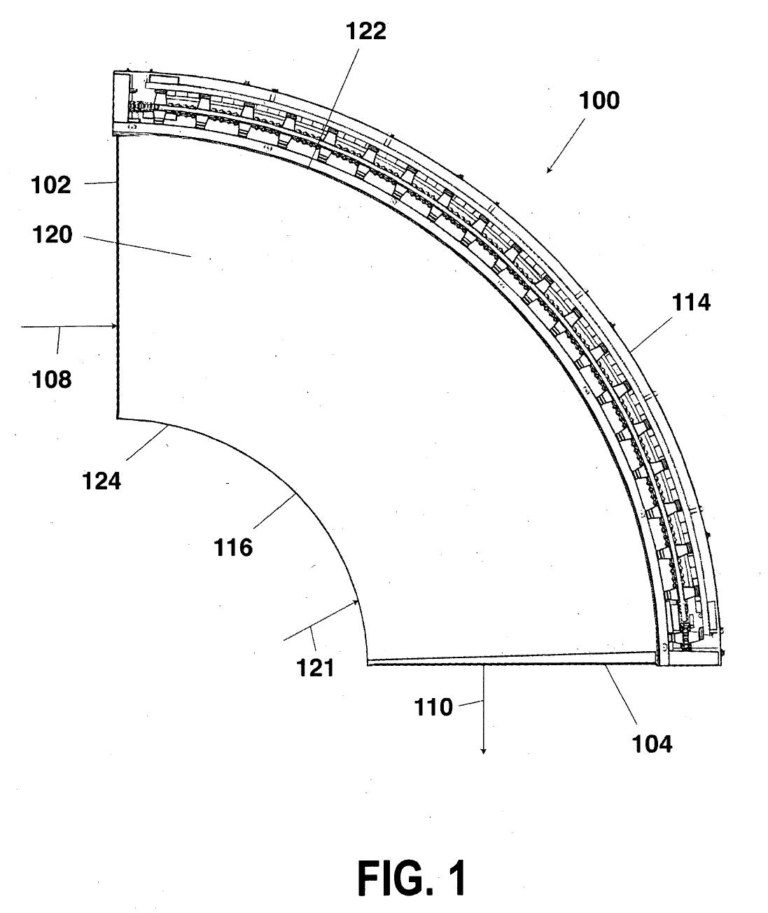

Conveyor systems using magnetic forces to orient a belt and provide tension on a belt are described herein. One embodiment of such a conveyor system is shown in FIG. 1, which is a top plan view of a belt-type conveyor system 100. The conveyor system 100 is a horizontal, curved conveyor. However, the conveyor 100 may be virtually any other type of conveyor, such as a straight conveyor, a conveyor that is not horizontal, a spiral type conveyor, or a conveyor that turns 180 degrees.

The conveyor 100 has a first end 102 and a second end 104, wherein items are conveyed between the first end 102 and the second end 104. Because the conveyor 100 of FIG. 1 is curved, items may enter the first end 102 traveling in a first direction 108 and exit the second end 104 traveling in a second direction 110. The angle between the first direction 108 and the second direction 110 may be virtually any angle. In a straight conveyor, the first direction 108 is substantially the same as the second direction 110.

The conveyor system 100 has an outer frame 114, sometimes referred to as a first member, and an inner frame 116 located opposite the outer frame 114. The outer frame 114 and the inner frame 116 may extend at least partially between the first end 102 and the second end 104 of the conveyor 100. Both the first end 102 and the second end 104 may have pulleys or rollers located therein and are described in greater detail below.

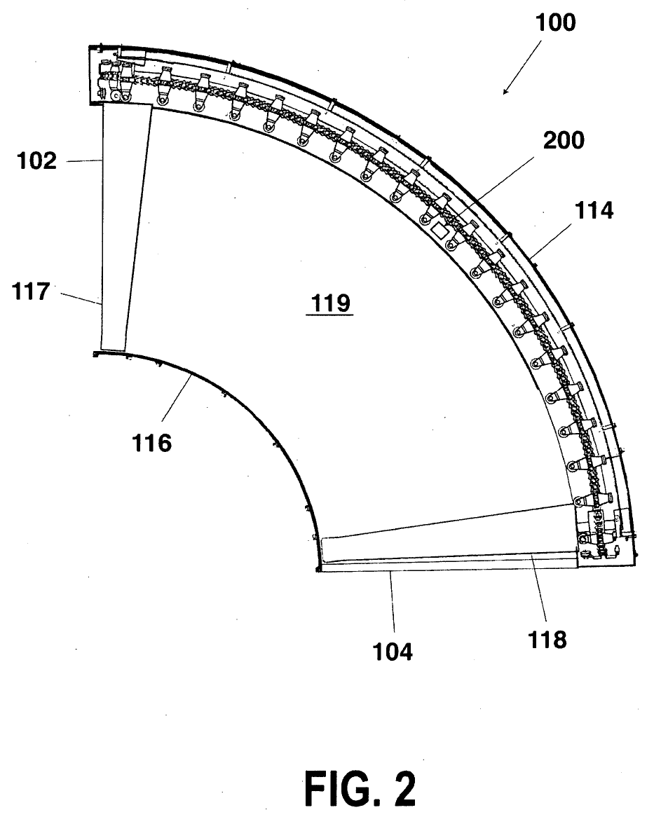

With additional reference to FIG. 2, which is a view of the conveyor system 100 of FIG. 1 with the belt (described below) removed, the conveyor system 100 has two rollers 117, 118. A first roller 117 is located proximate the first end 102 and a second roller 118 is located proximate the second end 104. The rollers 117, 118 may extend substantially between the outer frame 114 and the inner frame 116. Because the conveyor system 100 described herein is curved, the rollers 117, 118 are tapered in order to accommodate a conical-shaped belt. In some embodiments, pulleys may be used in place of at least one of the rollers 117, 118. A platform 119 extends between the first roller 117 and the second roller 118 and is used to support the belt as described below. It is noted that other support mechanisms, such as rollers and the like may be used to support the belt.

A continuous belt 120 extends and travels between the first end 102 and the second end 104. More specifically, the belt 120 passes over the aforementioned rollers 117, 118. The belt 120 has a first side 122 and a second side 124, which is opposite the first side 122. The first side 122 is located proximate the outer radius of the conveyor curve and the second side 122 is located proximate the inner radius of the conveyor curve. As described above, the belt 120 sets and slides on the platform 119. The belt material and platform material may be chosen to have a low coefficient of friction.

Due to the nature of curved conveyors, the tension of the belt 120 must be maintained on the rollers 117, 118, otherwise, the belt 120 will slip off the rollers 117, 119. More specifically, a force in the direction 121 along the radius of the curved conveyor 100 must be maintained. The conveyor 100 described herein uses magnetic forces to maintain the belt first side 122 proximate the outer frame 114, which serves to maintain belt tension on the rollers 117, 119.

Conventional conveyors, including curved conveyors, are limited in the speed at which the belt can travel because they use rollers and/or guides, and other mechanisms, to maintain the belt first side proximate the outer frame. These rollers, guides, and other mechanisms have friction, which limits the speed at which the belt can travel. The friction also causes the belt to become unstable at high speeds. In addition, the friction requires a great amount of power to move the belt. The friction also generates substantial noise when the conveyor operates. As described in greater detail below, the conveyor 100 described herein overcomes theses problems by replacing the rollers, guides, and other mechanisms with magnets and/or magnetic forces. Therefore, frictionless magnetic forces are used to maintain the belt first end 122 proximate the outer frame 114.

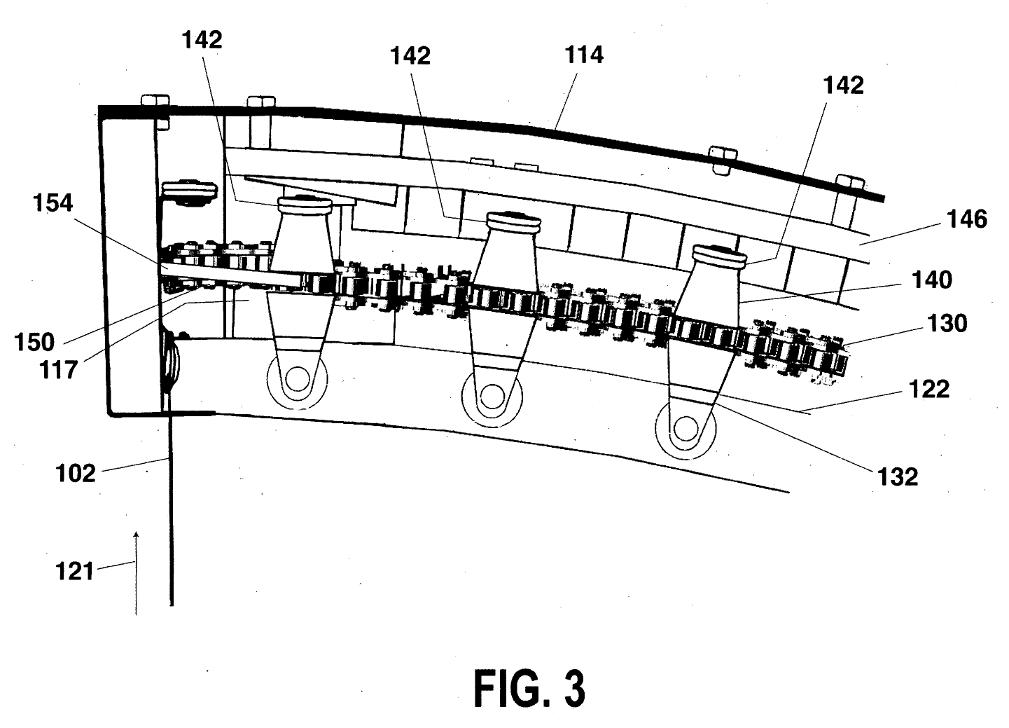

An exploded view of the first end 102 of the conveyor 100 is shown in FIG. 3. The view of FIG. 3 has covers removed so that the components within the conveyor 100 are visible. The conveyor 100 includes a movement mechanism, which in the embodiment of FIG. 3 is a chain 130. The chain 130 is connected to the belt 120 by way of a plurality of first connectors 132. The chain 130 is also connected to a plurality of magnets 142 by way of a plurality of second connectors 140.

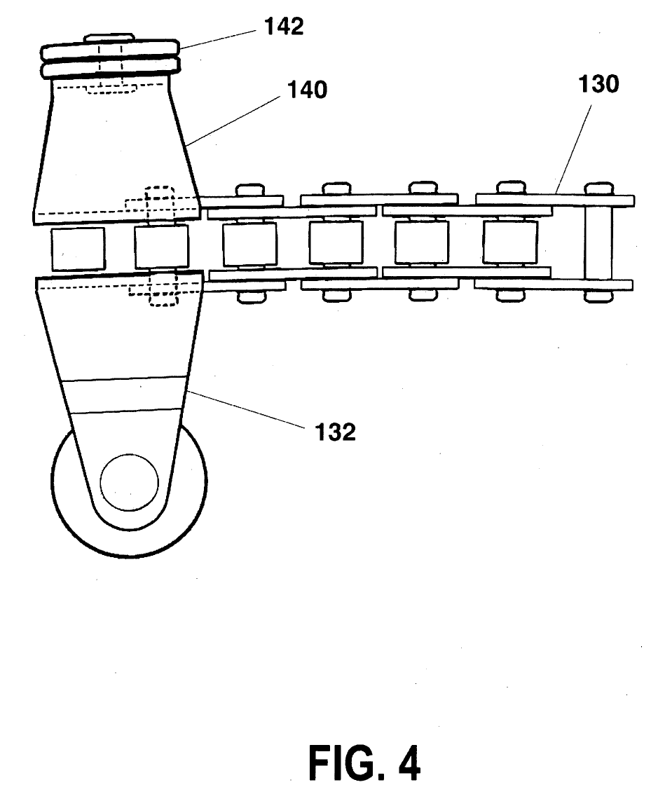

An exploded view of an embodiment of the chain 130 is provided in FIG. 4. As shown in FIG. 4, the first connectors 132 and the second connectors 140 may be links within the chain 130. It is noted that in some embodiments, the second connectors 140 may be connected to magnetic materials or magnets. In some embodiments, the first connectors 132 and the second connectors 140 may be a single unit attached to the chain 130. It is noted that drive mechanisms other than the chain 130 may be used within the conveyor 100. For example, the chain 130 may be replaced by a cable.

Referring again to FIG. 3, located proximate the magnets 142 is a first rail 146. The first rail 146 may be fixed relative to the outer frame 114. In some embodiments, the first rail 146 is comprised of magnetic material. In some embodiments, the first rail 146 comprises a plurality of magnets. Regardless of the magnet configuration, magnetic force attracts the second connectors 140 to the first rail 146. Accordingly, a force is applied on the belt 120 in the direction 121 by the magnetic forces. In some embodiments, the magnets 142 are configured so that a first polarity faces the first rail 146. The first rail 146 is magnetized or has magnets located therein so that the polarity opposite the first polarity faces the magnets 142.

The rail 146 is shown as being offset or spaced from the outer frame 114. This spacing prevents magnetic material, such as steel, within the conveyor 100 from acting upon or adversely affecting the above-described magnetic forces. In some embodiments, the rail 146 may be attached to the outer frame 114. In other embodiments, a nonmagnetic material, such as aluminum or stainless steel, may be placed between the rail 146 and the outer frame 114.

A drive mechanism, such as a motor moves the chain 130, which moves the belt 120. In addition, the chain 130 may be connected to the rollers 117, 118, FIG. 2. In the these embodiments, the first roller 117 may be attached to a sprocket 150, which is also connected to the chain 130. Thus, as the chain 130 moves, the first roller 117 also moves. In other embodiments, the first roller 117 is not connected to the sprocket 150 and the first roller 117 moves by way of movement of the belt 120. The sprocket 150 may then serve to guide the chain 130 and may also be connected to the drive mechanism so as to drive the chain 130.

The magnetic forces described above maintain the first belt end 122 proximate the outer frame 114 without the use of rollers, guides, or other devices, which significantly reduces friction and the above-described problems associated with friction. Therefore, as the belt 120 moves, the belt first end 122 is forced toward the outer frame 114 by the magnetic forces. This situation enables the belt first end 122 to remain taunt without friction generating devices. It is noted that the magnetic forces also support the belt first end 122 in the vertical direction so sagging of the belt first end 122 is minimized. Supporting the belt 120 in the vertical direction may be accomplished by selecting the magnets 142 and the rail 146. For example, if the magnets 142 have substantially the same height as the rail 146, the vertical position of the belt 120 is better maintained.

In some embodiments, a chain rail 154 may be provided. The chain rail 154 may extend the length of the conveyor system 100 and serves to keep the chain 130 from oscillating or becoming unstable. The chain rail 154 may slightly contact the chain 130 and may be made of a material that has very low friction relative to the chain 130. In some embodiments, the chain 130 rolls on the chain rail 154.

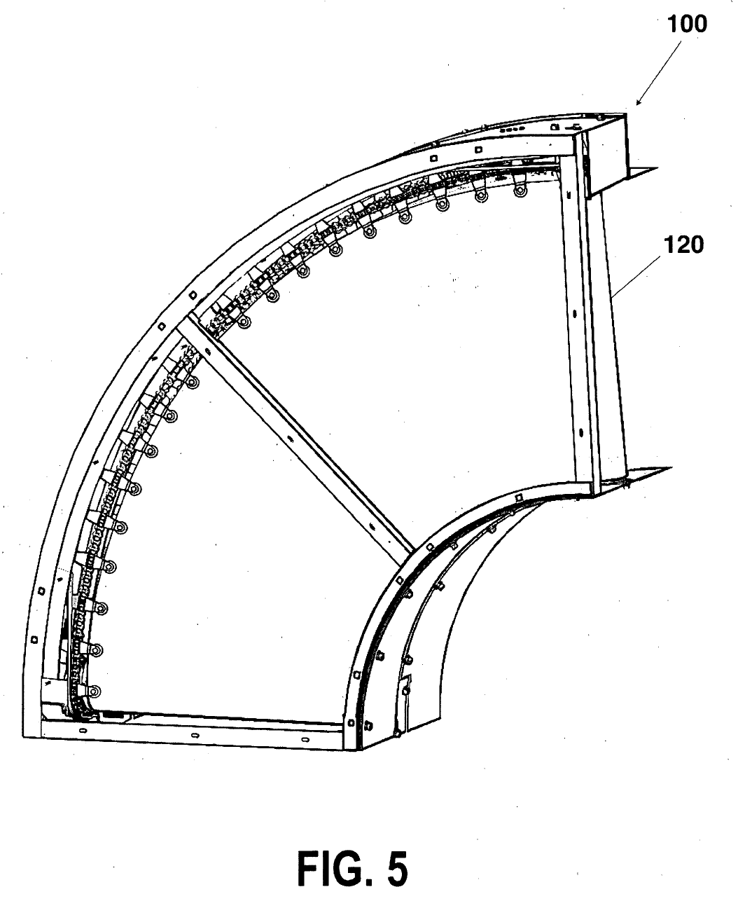

Having described the top portion of the conveyor 100, the bottom portion will now be described. When the belt 120 is described in the lower section of the conveyor 100, it is referred to as being in the return path. Accordingly, the return path refers to the path of the belt 120 when it is not conveying items. In some embodiments, the magnet and rail system described above may be used to support the belt 120 in the return path. Because the return path does not necessarily have a platform to support the belt 120, rollers or pulleys (not shown in FIG. 5) may be provided to support the belt. The rollers or pulleys may extend between the outer frame 114 and the inner frame 116. The number and type of rollers is a design consideration and may depend on the type of belt, the length of the conveyor, the speed of the belt, and other considerations. Other embodiments of the return path will be described below.

Having described some embodiments of the conveyor system 100, its operation will now be described. Other embodiments of the conveyor system 100 will be described further below. Referring to FIGS. 1-3, the belt 120 is maintained in position by the magnetic forces exerting a force on the belt 120 in the direction 121. The force of the belt 120 is applied to the tapered rollers 117, 118. Therefore, the belt 120 is kept in constant tension by the magnetic forces. The amount of tension may be controlled by the flux of the magnets used therein and the distance between the second connectors 140 and the first rail 146.

A drive mechanism moves the chain 130, which is connected to the belt 120 via the first connectors 132. Thus, the belt 120 moves as the chain 130 moves. As the belt 120 moves, it slides on the platform 119 and rolls on the rollers 117, 118. In the return path, the belt 120 may be supported by rollers as described above. Therefore, during operation, the only friction in the conveyor 100 is in the drive mechanism, the rollers 117, 118, and between the platform 119, and the belt 120. Therefore, the power required to operate the conveyor 100 is much less than the power required to operate a conventional conveyor. In addition, the noise of the conveyor 100 is much less than the noise of a conventional conveyor. The use of the magnetic forces to maintain the belt 120 in tension stabilizes the belt 120 relative to conventional conveyors. Therefore, the belt 120 is able to operate at higher speeds than belts used in conventional conveyors.

Some embodiments of the conveyor of FIGS. 1-3 will now be described. Different magnetic configurations between the first rail 146 and the second connectors 140 may be used. For purposes of this specification, the term magnetic material is a material, such as iron or steel, that is attracted to a magnet or acts under a magnetic force. The embodiments described above have magnets attached to the second connectors 140 and the first rail 146 is magnetic or has magnets located therein. In another embodiment, the first rail may be comprised of a magnetic material such that the magnets 142 attached to the second connectors 140 are attracted to the first rail. In another embodiment, the first rail is magnetic, the second connectors 140 comprise magnetic material, and the magnets 142 are not used. In this embodiment, the magnetic first rail 146 attracts the second connectors 140. In some embodiments, the chain 130 is made of a magnetic material, which increases the magnetic attraction to the first rail 146.

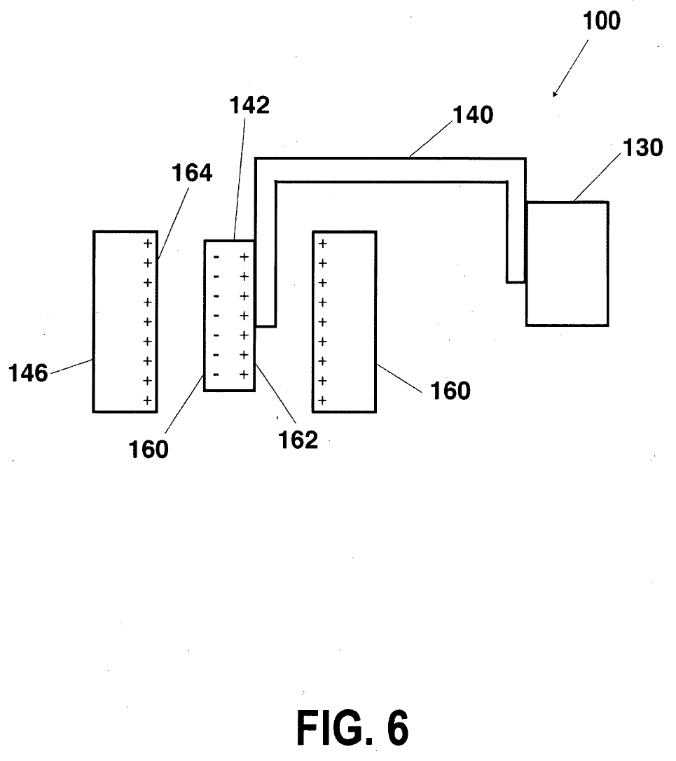

A side cutaway view of another embodiment of the conveyor 100 is shown in FIG. 6. In this embodiment, two magnetic rails 146, 160 are provided in order to increase the magnetic force applied to the second connectors 140. The second connectors 140, the magnets 142, and the first rail 146 may be the same as described above. However, the second connectors 140 may be made of a nonmagnetic material, such as stainless steal. The magnets 142 have a first face 160 having a first polarity and an opposite face 162 having the opposite polarity. The first rail 146 has a face 164 that is polarized opposite the polarity of the first face 160 of the magnets 142. Thus, there is magnetic attraction between the magnets 142 and the first rail 146. Additional magnetic force is generated by the second rail 160. The second rail 160 has a face that is magnetized, or has magnets located therein, with a polarity that is the same as the polarity of the second face of the magnets 142. Therefore, the second rail increases the magnetic force applied to the connectors 140 via a magnetic repulsion force.

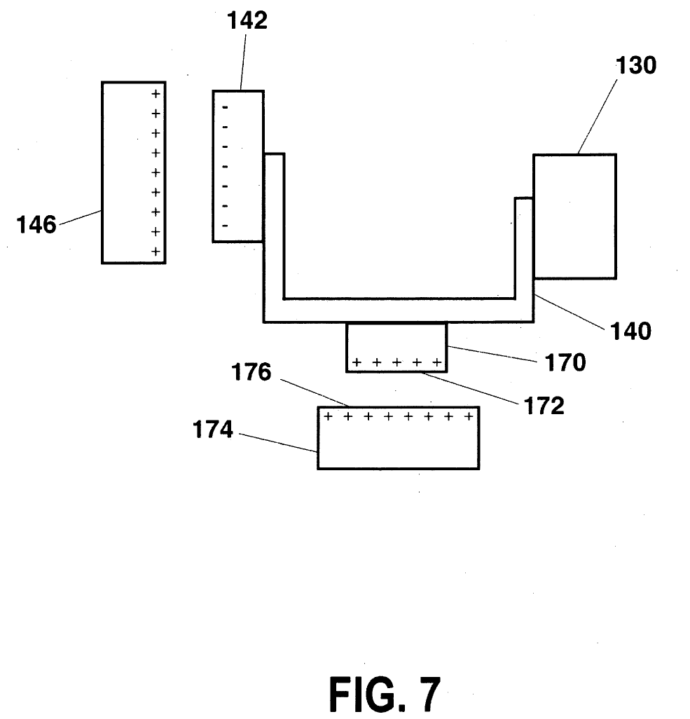

An alternate version of the return path is shown in FIG. 7, which is a partial cutaway view of the association between the second connectors 140 and the rail 146. In this embodiment, a second magnet 170 is mounted to the first connector. The second magnet 170 has a face 172 that is polarized. A third rail 174 is provided proximate the second magnet 170. The third rail 174 has a face 176 that is magnetized with the same polarity as the face 172 of the second magnet 170. The configuration of the second magnet 170 and the third rail 174 serves to repel the second connector 140, which supports the belt 120 in the vertical direction in the return path.

The conveyor 100 has been described as a curved conveyor. However, it is possible to use the magnetic forces in a straight conveyor. In a straight conveyor, forces are not required to pull on the sides of the belt as this tension is not as critical. Therefore, magnetic configurations as shown in FIG. 6 may be employed with both rails 146, 160 repelling the magnets 142. Accordingly the face 164 of the first rail 146 may be polarized so as to be the same as the first face 160 of the magnets 142. Such a configuration will orient the belt in a straight conveyor. In a similar embodiment, both sides of the belt and conveyor may have a magnetic configurations as described above.

Some uses of the conveyor 100 may cause the belt 120 (FIG. 2) to move slightly in a direction opposite the direction 121. For example, if a heavy load is suddenly placed on the belt 120, the belt may move slightly in the direction opposite the direction 121. Because magnetic force is exponentially proportional to distance, this slight shift of the belt may cause the magnets 142 to be out of the effective range of the first rail 146. In order to overcome this issue, the conveyor 100 may have a chain retainer 200 or a plurality of chain retainers 200 located therein. In summary, the chain retainer 200 prevents the chain 130, and thus, the magnets 142 from moving too far from the first rail 146. Therefore, the magnets 142 are always maintained within an effective distance of the first rail 146.

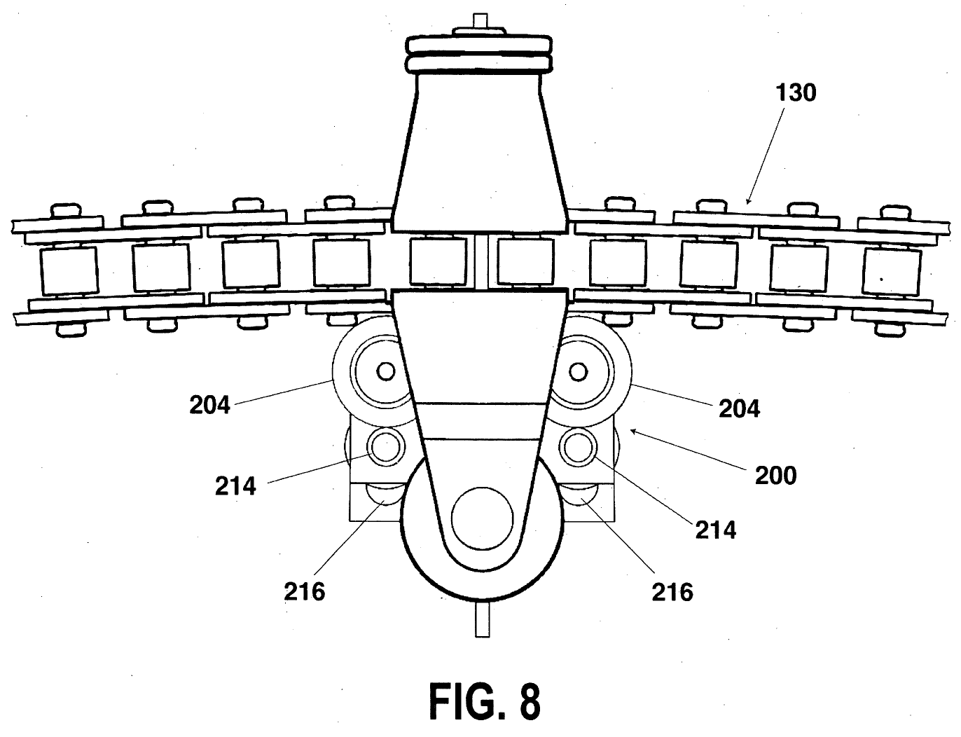

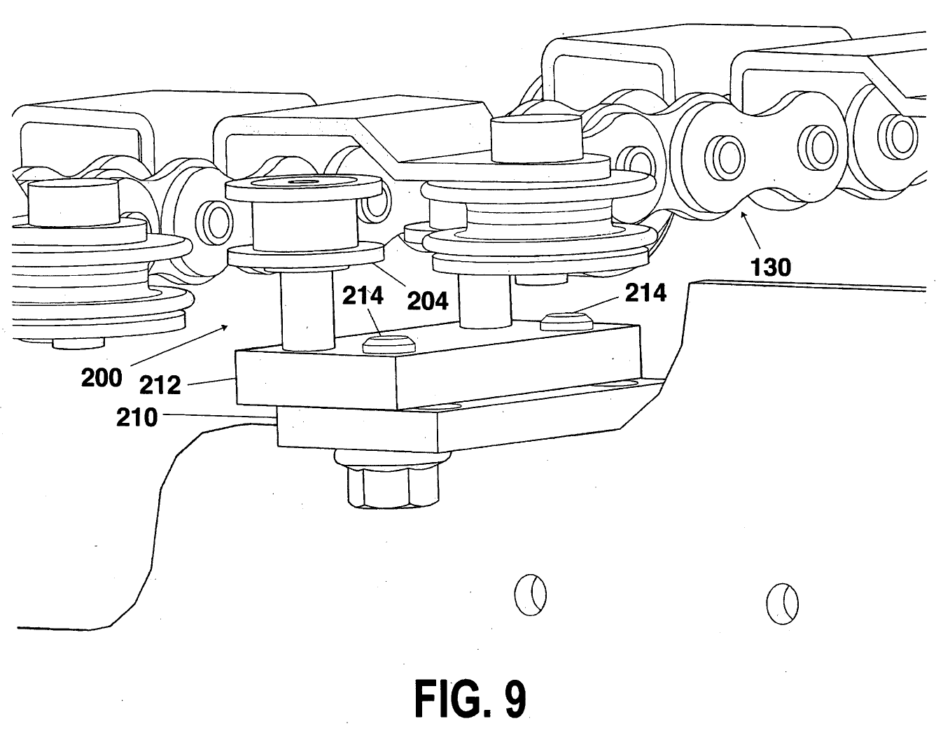

A top view of an embodiment of the chain retainer 200 is shown in FIG. 8 and a side view of the chain retainer 200 is shown in FIG. 9. The chain retainer 200 is fixed to a chassis member or other non-movable device within the conveyor 100. The chain retainer has at least one roller 204 that is able to contact the chain 130. The embodiment of the chain retainer 200 described herein has two rollers 204. The rollers 204 may contact the chain 130 during operation or when the belt 120 moves as described above. The use of the rollers 204 adds very little friction and noise to the conveyor 100, so the use of the chain retainer 200 has very little impact on the operation of the conveyor 100.

The chain retainer 200 has a first plate 210 that mounts to a chassis as described above. A second plate 212 is movably attached to the first plate 210. Retainers 214 are movable in slots 216, which allow the second plate 212 to move relative to the first plate 210. The movement enables the chain retainer 200 to maintain the position of the chain at very precise points.

The number of chain retainers 200 used in a conveyor depends on the radius of the conveyor, the shape of the conveyor and the loads placed on the conveyor. For example, a unshaped conveyor transporting heavy loads may need three. A ninety degree turn conveyor may only need one. A straight conveyor may not need any.

It is noted that devices other than chains may move the belt 120. Accordingly, the above-described chain retainer 200 may serve to act on these other devices in a substantially similar manner as the chain 130.

What is claimed is:

1. A conveyor comprising:
a first end;
a second end;
a belt extending between said first end and said second end, said belt having a belt first side;
wherein a magnetic force acts on said belt first side.

2. The conveyor of claim 1, and further comprising a first member located proximate said belt first side, and wherein said magnetic force acts between said first member and said belt first side.

3. The conveyor of claim 2, wherein said magnetic force is an attracting force.

4. The conveyor of claim 2, wherein said magnetic force is a repelling force.

5. The conveyor of claim 2, wherein said first member is magnetized and wherein said belt first side has a magnetic material attached thereto.

6. The conveyor of claim 2, wherein said belt first side has a magnet attached thereto and wherein said first member comprises a magnetic material.

7. The conveyor of claim 2, wherein said first member is magnetized with a first polarity, said first member being proximate said belt first side, and wherein said belt first side comprises at least one magnet having a second polarity, opposite said first polarity, said at least one magnet being located proximate said first member during at least a portion of the travel of said belt.

8. The conveyor of claim 2, and further comprising a second member, wherein at least a portion of said belt first side is located between said first member and said second member during at least a portion of the travel of said belt; wherein a first magnetic force acts between said first member and said belt first side, and wherein a second magnetic force acts between said belt first side and said second member.

9. The conveyor of claim 8, wherein said first magnetic force is attractive and wherein said second magnetic force is repulsive.

10. The conveyor of claim 1, and further comprising a platform located between said first end and said second end, wherein said belt sets on said platform during at least a portion of travel between said first end and said second end, and wherein said belt first side extends beyond said platform.

11. The conveyor of claim 1, and further comprising a retainer, wherein said retainer prevents the belt first side from moving a predetermined distance from said first rail.

12. The conveyor of claim 1, wherein said magnetic force acts to lift said belt first side.

13. The conveyor of claim 1, wherein said belt comprises a second side located opposite said first side, and wherein a second magnetic force acts on said second side of said belt.

14. The conveyor of claim 1, wherein said magnetic force acts on said belt first side in a direction substantially normal to the direction of movement of said belt.

15. The conveyor of claim 13 and further comprising a second member located proximate said second side of said belt, and wherein said second magnetic force acts between said second side of said belt and said second member.

16. A conveyor comprising:
a first end;
a second end;
a first member extending at least partially between said first end and said second end;
a belt extending and movable between said first end and said second end, said belt having a belt first side located proximate said first member; and
a magnetic force between said belt first side and said first member.

17. The conveyor of claim 16, wherein said belt first side has at least one magnet attached thereto and wherein said first member comprises at least one magnetic material so as to attract said at least one magnet.

18. The conveyor of claim 16, wherein said belt first side has at least one magnetic material attached thereto and wherein said first member is magnetized so as to attract said at least one magnetic material.

19. The conveyor of claim 16 and further comprising a retainer wherein said retainer maintains said first side of said belt within a predetermined distance from said first member.

20. The conveyor of claim 16, wherein said belt first side has a first magnet attached thereto, said first magnet having a first polarity facing said first member, and wherein said first member has a second magnet attached thereto, said second magnet having a second polarity facing said first magnet; said first polarity being opposite of said second polarity.

21. The conveyor of claim 16, wherein said belt comprises a second side located opposite said first side, and wherein said conveyor further comprises a second member located proximate said second side of said belt; and wherein a second magnetic force acts between said second side of said belt and said second member.
